(19) United States
(12) Patent Application Publication
(10) Pub. No.: US 2010/0321028 A1
(43) Pub. Date: Dec. 23, 2010

(54) SYSTEM AND METHOD FOR DETERMINING THE PERFORMANCE OF A WEARABLE ELECTRODE

(75) Inventors: Xiao-ming Tao, Kowloon (HK); Rong-xin Wang, Kowloon (HK); Xin-sheng Li, Kowloon (HK); Hao Liu, Kowloon (HK)

Correspondence Address: KAUTH , POMEROY , PECK & BAILEY ,LLP, 2875 MICHELLE DRIVE, SUITE 110, IRVINE, CA, 92606, US

(73) Assignee: The Hong Kong Polytechnic University, Kowloon (HK)

(21) Appl. No.: 12/487,098

(22) Filed: Jun. 18, 2009

(51) Int. Cl. G01N 27/60

(52) U.S. Cl. 324/453

(57) ABSTRACT

A system (100) for determining the performance of a wearable electrode, the system (100) comprising: a container (37) of liquid to simulate a static or dynamic environment for the electrode; a measurement module (2) to analyse and record predetermined properties of the electrode in response to passing an electrical current through the liquid during operation in the simulated environment to determine the performance of the electrode.

### TECHNICAL FIELD

The invention concerns a system and method for determining the performance of a wearable electrode.

### BACKGROUND OF THE INVENTION

There lacks an effective means to determine the stability, repeatability, precision, durability of a wearable electrode. Traditional methods and systems to evaluate the performance of a wearable electrode require a long period of time for the measurement of biological signals. Consequently, this is inconvenient and has limited reproducibility, accuracy and selectivity. For example, a patient must wear an adhesive or attach electrodes for a long period time in order to measure ECG, respiration, impedance, etc. With specific reference to an intelligent textile electrode, a very complex operational environment is encountered. This environment has many parameters which can influence the measured data including moisture of the skin, blood fluid rate, contact status between the electrode and skin.

### SUMMARY OF THE INVENTION

Methods and systems in accordance with embodiments of the invention replace the traditional method and system for evaluating the performance of a wearable electrode. Furthermore, methods and systems in accordance with many embodiments of the invention are able to consider variable shape and volume of a user wearing an electrode.

In a first preferred aspect, there is provided a method for determining the performance of a wearable electrode. The method includes simulating a static or dynamic environment using at least a container of liquid. The method also includes passing an electrical current through the liquid of the container. Predetermined properties of the electrode in response to passing the electrical current through the liquid during operation in the simulated environment are analysed and recorded to determine the performance of the electrode.

The simulated environment may be any one from the group consisting of: simulating a skin condition, circulation of the liquid, setting a temperature for the liquid and/or container, and moving the container.

The predetermined properties of the electrode may include any one from the group consisting of: impedance, voltage offset, noise and durability.

The electrode may be positioned in direct contact with the liquid or is in contact with a membrane or solid cover covering the container of liquid.

The membrane may be an artificial membrane or a natural skin such as an animal skin.

The artificial membrane may be ventilated, water-resistant or is a soaked membrane.

The solid cover may be made from any one from the group consisting of: organic material and polymeric material without ion release.

The liquid may be any one from the group consisting of: human perspiration, artificial perspiration, and a solution of electrolytes to simulate water found inside cells, intracellular fluid (ICF) or extracellular fluid (ECF) of a living organism, the electrolytes containing Cl⁻Na⁺K⁺,Ca⁺, H⁺, O⁻, Mg⁺, Mn⁺, Cr⁺, Fe⁺, or Ir⁺.

The electrode may be rigid or flexible.

The frequency of the electrical current may be altered from a low frequency to simulate passing through the ECF to a high frequency to simulate passing through both the ICF and ECF.

A medical gel or conductive gel may be applied between the electrode and the membrane or solid cover.

The container may be moved using any one from the group consisting of: a multidimensional movement system, manual stage controllers and computer-assisted stage controllers.

In a second aspect, there is provided a system for determining the performance of a wearable electrode. The system includes a container of liquid to simulate a static or dynamic environment for the electrode. The system also includes a measurement module to analyse and record predetermined properties of the electrode in response to passing an electrical current through the liquid during operation in the simulated environment to determine the performance of the electrode.

The system may further comprise a force control module to mechanically move the electrode.

There may be two measurement modules.

The electrode may be positioned in direct contact with the liquid or is in contact with a membrane or solid cover covering the container of liquid.

The membrane may be an artificial membrane or a natural skin such as an animal skin.

The artificial membrane may be ventilated, water-resistant or is a soaked membrane.

The solid cover may be made from any one from the group consisting of: organic material and polymeric material without ion release.

The liquid may be any one from the group consisting of: human perspiration, artificial perspiration, and a solution of electrolytes to simulate water found inside cells, intracellular fluid (ICF) or extracellular fluid (ECF) of a living organism, the electrolytes containing Cl⁻Na⁺K⁺,Ca⁺, H⁺, O⁻, Mg⁺, Mn⁺, Cr⁺, Fe⁺, or Ir⁺.

The force control module may be any one from the group consisting of: a multidimensional movement system, manual stage controllers and computer-assisted stage controllers.

The present invention is based on the kinesics and circulation of creatures to create various environments and conditions to simulate and to modify electrical measurement of electrodes.

The present invention allows temperature, pressure, speed and direction of motion and liquid flow rate to be controlled to measure and evaluate the performance a wearable electrode. This allows a systemic, managed and objectivity to perform multi parameter analysis of each wearable electrode.

The present invention enables future development of human-machine interface, interactive apparel, sports, rehabilitation and biometrics because various environmental conditions such as body shape, volume or dimensions in static and dynamic modes can be simulated for the flexible and wearable electrode.

### BRIEF DESCRIPTION OF THE DRAWINGS

An example of the invention will now be described with reference to the accompanying drawings, in which:

FIG. 1 is a system layout diagram of the simulation system according to a preferred embodiment of the present invention;

FIG. 2 is a block diagram of a measurement module of the system of FIG. 1;

FIG. 3 is a block diagram of a force control module of the system of FIG. 1;

FIG. 4 is a process flow diagram of installing the liquid container and the electrode to the system of FIG. 1;

FIG. 5 is a process flow diagram of the measurement process;

FIG. 6 is a control principle diagram of the system of FIG. 1;

FIG. 7 is a Nyquist plot of the electrodes measured without a membrane;

FIG. 8 is a Nyquist plot of the electrodes measured on a membrane;

FIG. 9 is a Nyquist plot of the measured electrodes moving on a membrane in one dimension;

FIG. 10 is a Nyquist plot of the measured electrodes moving on a membrane in two dimensions;

FIG. 11 is a Nyquist plot of the measured electrodes remaining statically on a membrane when the electrolyte is flowed by a pump;

FIG. 12 is a Nyquist plot of the measured electrodes moving in one dimension on a membrane when the electrolyte is flowed by a pump at room temperature;

FIG. 13 is a Nyquist plot of the measured electrodes moving in one dimension on a membrane when the electrolyte is flowed by a pump at high temperature; and

FIG. 14 is a perspective from above of the simulation system of FIG. 1.

### DETAILED DESCRIPTION OF THE DRAWINGS

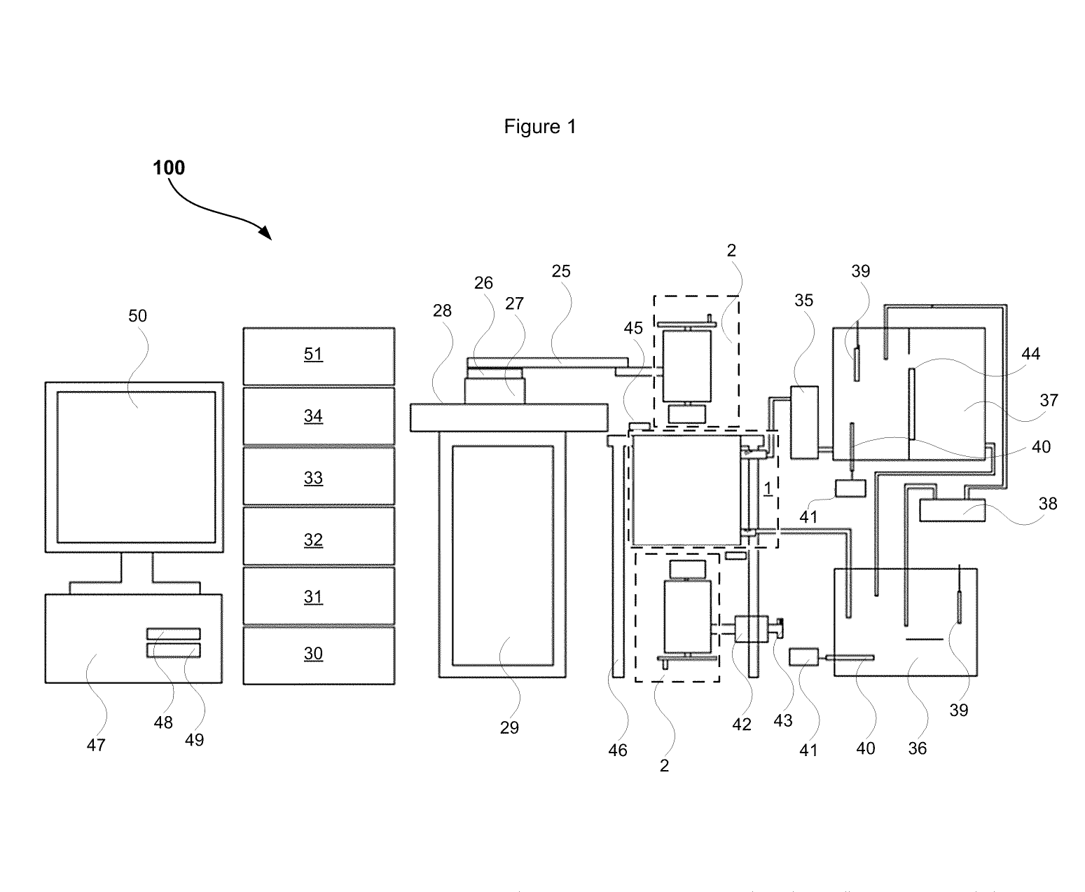

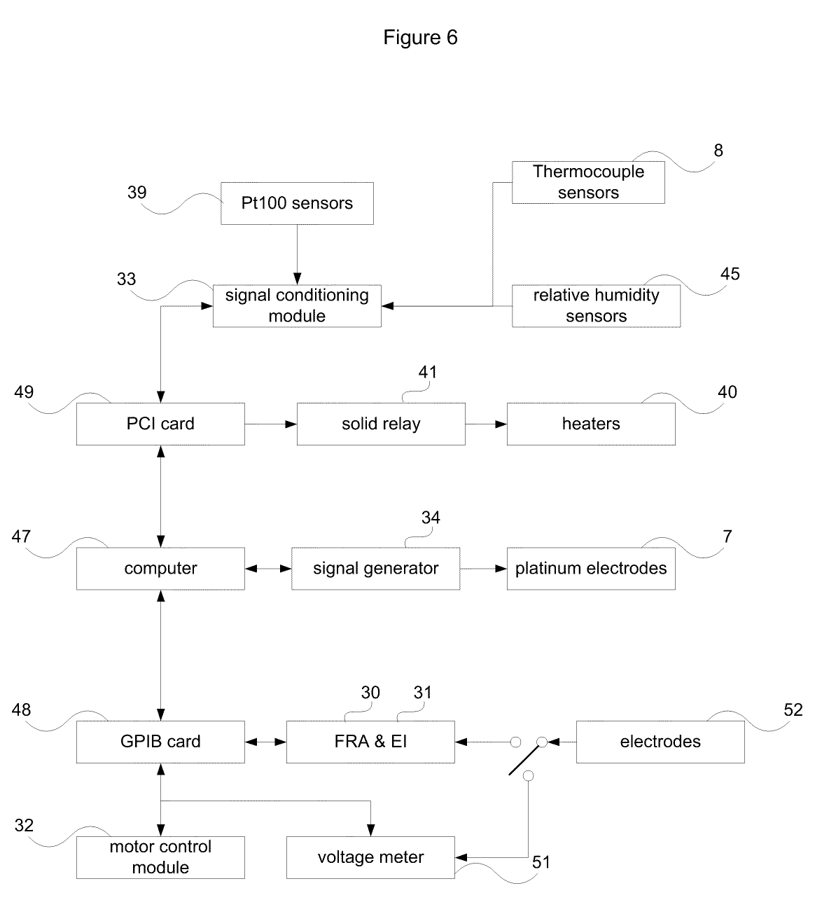

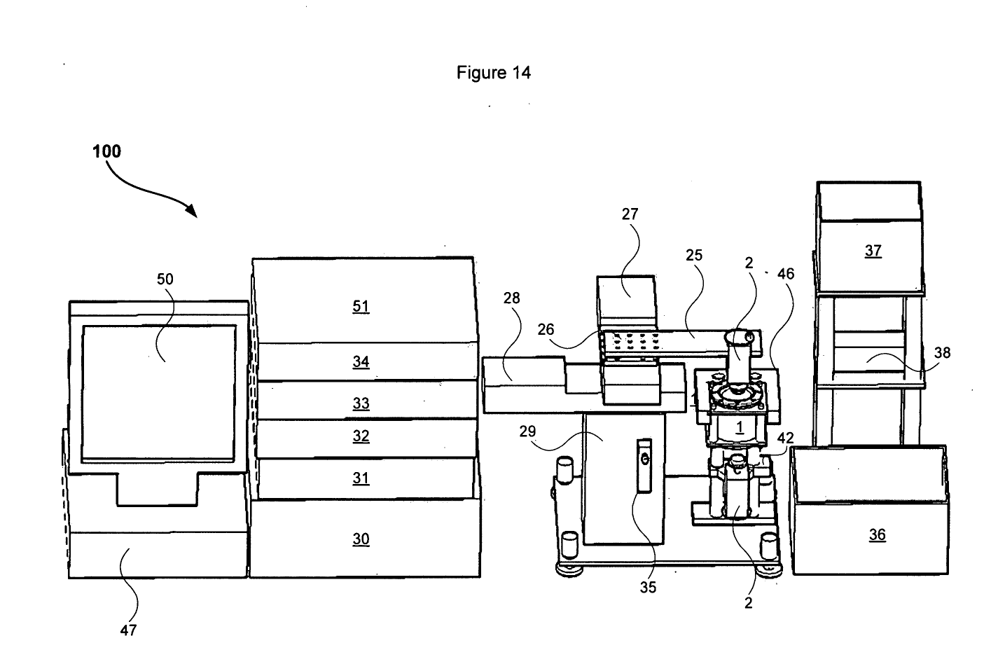

Referring to FIGS. 1, 6 and 14, a simulation system 100 for evaluating the performance of an electrode 52 is provided based on kinesics and circulatory of creatures. Any type of electrode 42 may be measured including those made from hard or flexible materials in various sizes or shapes. The system 100 allows a flexible electrode 52 to conform to various body shapes, volumes or dimension measurement under static and dynamic conditions. The properties of the electrode 52 to be evaluated include impedance, voltage offset, noise and durability. The system 100 generally comprises six parts to simulate and to create static and dynamic profile in different temperature atmosphere, force and fluid flow rate by controlling temperature, pressure, fluid flow rate (for example, blood circulation) and liquid penetration amount (for example, amount of sweat). The six parts are: (1) liquid containers to store artificial sweat/electrolyte; (2) a fluid circulation system including pumps, fluid rate controllers, heaters and temperature controllers; (3) a mechanical movement system; (4) measured sample holders; (5) contacts between measured sample and the container of electrolyte; and (6) data collection, data processing and analysis, and calibration of the system 100. The system 100 enables different conditions for skin and flowing circulation to be created. The system 100 also enables movement of a living body to be simulated in a static or dynamic state for a prolonged period of time. The electrical signal measured by the electrode 52 is used to evaluate and analyze the quality and properties of the electrode 52.

The electrode 52 to be evaluated is placed within a solution or placed on an artificial membrane or on natural skin. The electrode 52 may remain in a static position or may be moved during measurement. Assistive materials may be used for measurement requiring multi-dimension movement to conveniently simulate the effect of movement of a living body when an electrical signal is measured by the electrode 52.

A top container liquid level adjusting valve 44 controls the amount of liquid flowing into a top container 37 from a bottom container 36. The containers 36, 37 are used for simulating living creatures in a static state. A fluid pump 38 pumps liquid from the bottom container 36 to the top container 37. A flow meter 35 is connected on the other end of the each pipe port 30. The flow meter 35 connects the top container 37 with a liquid level adjusting valve 44. Platinum resistor (PT100) sensors 39 and heaters 40 are placed in both the top container 37 and the bottom container 36. The adjusting valve 44 and the flow meter 35 are used to control the flow rate of the liquid. The PT100 temperature sensors 39 measure the temperature of the liquid and provide a temperature value for controlling the temperature of liquid. The heaters 40 are connected to a solid relay 41 by electrical wires. The heaters 40 provide heat to the liquid so that the performance of the electrode 52 under different temperature conditions can be measured.

The PT100 sensors 39, thermocouple sensors 8 and relative humidity sensors 45 are connected to a signal conditioning module 33 by electrical wires. This enables temperature and humidity to be monitored and also their affect on the electrode 52 is recorded. The signal conditioning module 33 and solid relay 41 are connected to a PCI card 49 by electrical wires.

Work electrodes 52 can be connected with either an electrochemical interface (EI) 31 or a voltage meter 51 in terms of experimental demand. The work electrodes 52 may be wearable electrodes for obtaining the bioelectric signal of a human body. The platinum electrodes 7 are connected to a signal generator 34 by electrical wires. The platinum electrodes 7 are reference electrodes and provide an excitement signal that is generated by the signal generator 34. The signal generator 34 can generate all kinds of signals such as square wave, sine wave, and other complicated waves. A frequency response analyzer (FRA) 30, the EI 31 and the voltage meter 51 are connected to the GPIB card 48. The PCI card 49, signal generator 34 and GPIB card 48 are connected to a computer 47. The computer 47 has a display screen 50. The EI 31 provides the excitement voltage or voltage current and conditions the output voltage and current. The FRA 30 collects the output voltage and current. The voltage meter 51 measures the potential response of the work electrodes 52 when there is excitement signal that is generated by the signal generator 34 between the platinum electrodes 7. The GPIB card 48 and the PCI card 49 transport the voltage and current digital signal to the computer 47. The computer 47 and display screen 50 are used to analyze signal and display the data. The motor control module 32 connects the motor X 27 and motor Y 28 by electrical wires, and connects the computer by GPIB card 48. The motor control module 32 can control the direction, velocity, acceleration and deceleration of motor X 27 and motor Y 28, and these parameters can display on the display screen 50.

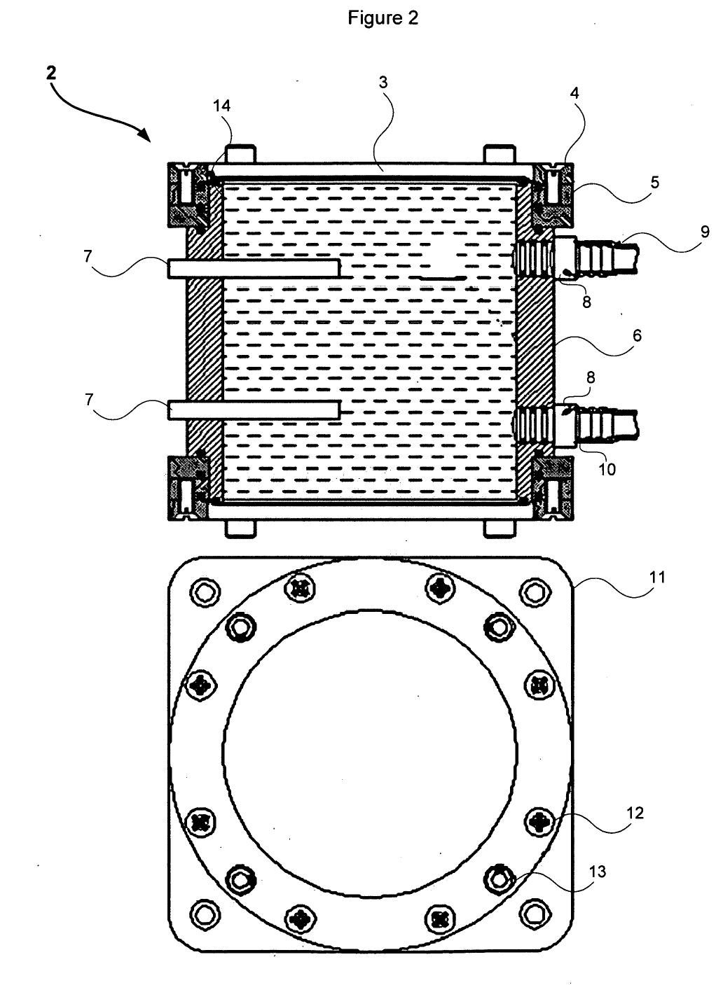

Referring to FIG. 2, there are two measurement modules 2 in the simulation system 100. The measurement modules 2 are used to store any types of liquids, solutions, electrolytes. Each measurement module 2 includes a barrel 6 with a pipe port 10 and two platinum electrodes 7. The barrel 6 is assembled to the measuring bracket 46. There are four holes in the sidewall of the barrel 6. Two of the four holes are for assembling the platinum electrode 7. The other two holes are for assembling two pipe ports 10 with three sealing rings 14.

Two cover holding plates 11 are installed over the two open ends of the barrel 6. A drilled millipore membrane 3 is placed between the inner cover torus 5 and outer cover torus 4 and is bound by the membrane fastening screws 12. The cover holding plate 11 is installed by cover fastening screws 13. At the edges of the inner cover torus 5, outer cover torus 4 and barrel 6, sealing rings are used to prevent leakage of liquid. Silicone hoses 9 are covered on each pipe port 10 with a thermocouple sensor 8. The flow meter 35 measures the amount of liquid flowing from the top container 37 through the pipe port 10. The thermocouple sensor 8 monitors the temperature of the barrel 6. The drilled millipore membranes 3 simulate the skin of a creature.

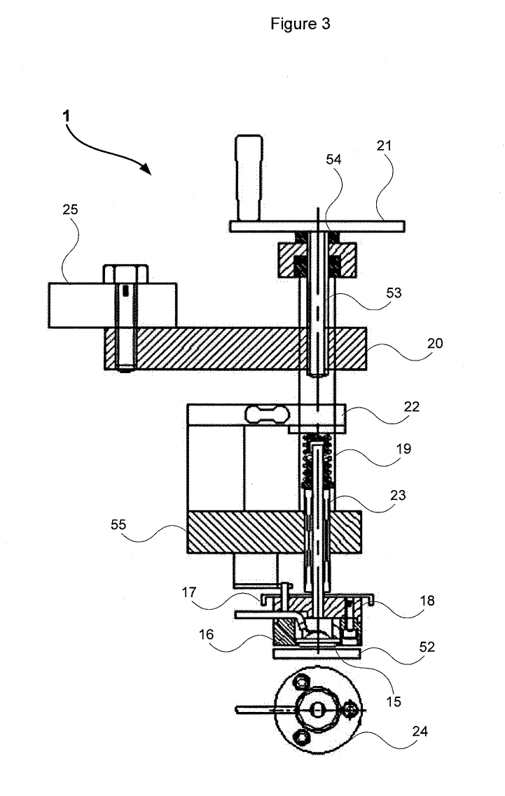

Referring to FIG. 3, there is a force control module 1 in the simulation system 100. The force control module 1 mechanically moves the electrode in multiple dimensions using controllers to simulate x-y direction plane or x-y-z direction stereo movement and to adjust pressure between the electrode and membrane or skin. The force control module 1 is assembled on a hanging arm 25 from a motor system. The hanging arm 25 is connected to an X-motor 27 and a Y-motor 28 by connector 26 from the X-motor 27. The entire motor system is assembled on motor bracket 29. The force control module 1 is assembled on a height adjusting sliding block 42 to enable it to be adjusted vertically. The force control module 1 is fixed in a certain position by tightening position lock screw 43. A contact button 15 is positioned between an inner cover 16 and outer cover 18. The contact button 15 is held in place by three contact button fastening screw 24. A leakage collector 17 for the work electrodes 52 is attached on the inner cover 16. The leakage collector 17 and inner cover 16 are connected to the end of linear bearing 23. A spring 19 is assembled between a strain gauge 22 and the linear bearing 23. The strain gauge 22 is installed on a gauge bracket 55. The gauge bracket 55 is connected to a position restricted block 54 and a force control module height adjusting screw 53. A fine tuning disc 21 is positioned above the position restricted block 54. The force control module 1 is installed on a support bracket 20 operatively connected to the hanging arm 25.

The contact button 15 connects with the work electrodes 52. The simulating bioelectric can be conducted to the El 31 via the contact button 15 and electrical wires. The linear bearing 23 can decrease the friction and increase the measurement accuracy of force. The spring 19 is a buffer unit of force. The strain gauge 22 can measure the force between the work electrodes 52 and the drilled millipore membrane 3. The fine tuning disc 21 can be turned to move the strain gauge 22 down or up gradually. Therefore the force is gradually changed. This provides a press-control method and device for quantitatively and qualitatively modifying the relationship between applied force and electrical signal.

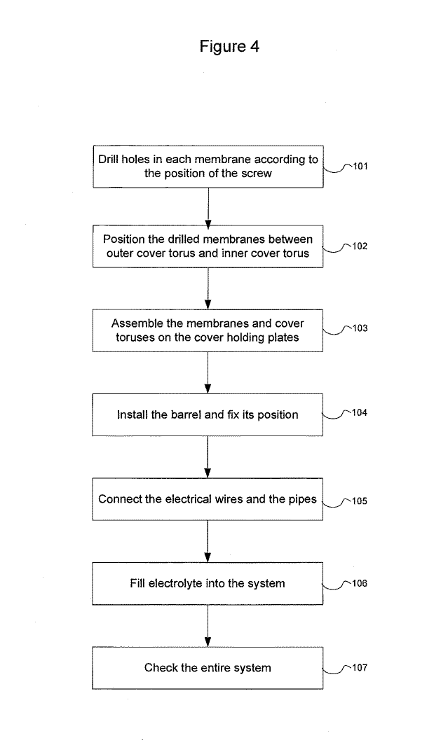

FIG. 4 depicts the installation process for the simulation system 100. Each membrane is drilled 101 with millipores 10 and placed according on the barrel in a position according to the screw holes. The drilled membranes are placed 102 between the outer cover torus and inner cover torus. The membranes and the cover toruses are assembled 103 on the cover holding plates. The barrel is installed 104 and its position is fixed. The electrical wires and pipes are all connected 105. The electrolyte is filed 106 in the system. The entire simulation system 100 is checked 107.

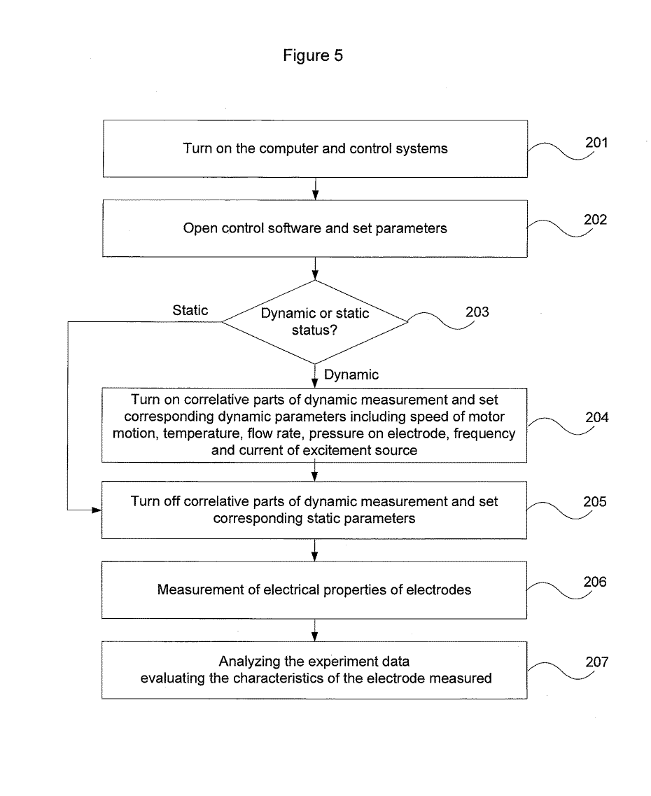

FIG. 5 depicts an electrode measurement process using the simulation system 100. The computer and controls systems are turned on 201. The control software is executed 202 and its parameters are set. The user inputs whether dynamic status or static status is to be measured 203. If dynamic status is to be measured, the correlative parts of the dynamic measurement are turned on in the simulation system 100. Corresponding dynamic parameters are set 204 including speed of the motor motion, temperature, flow rate, pressure exerted on electrode, frequency and current of excitement source. Next, the correlative parts of the dynamic measurement are turned off 205 and the corresponding static parameters are set 205. The electrical properties of the electrodes are measured 206. The experimental data is analysed 207 to evaluate the characteristics of the electrode that was measured.

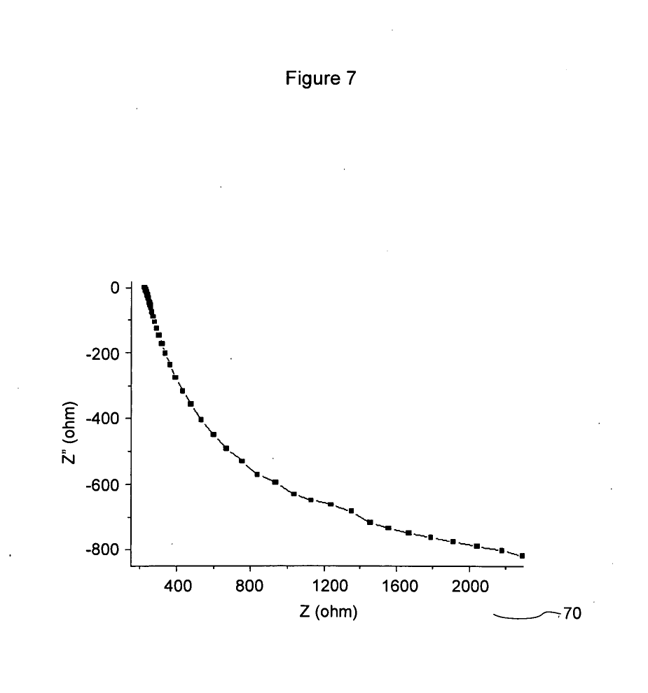

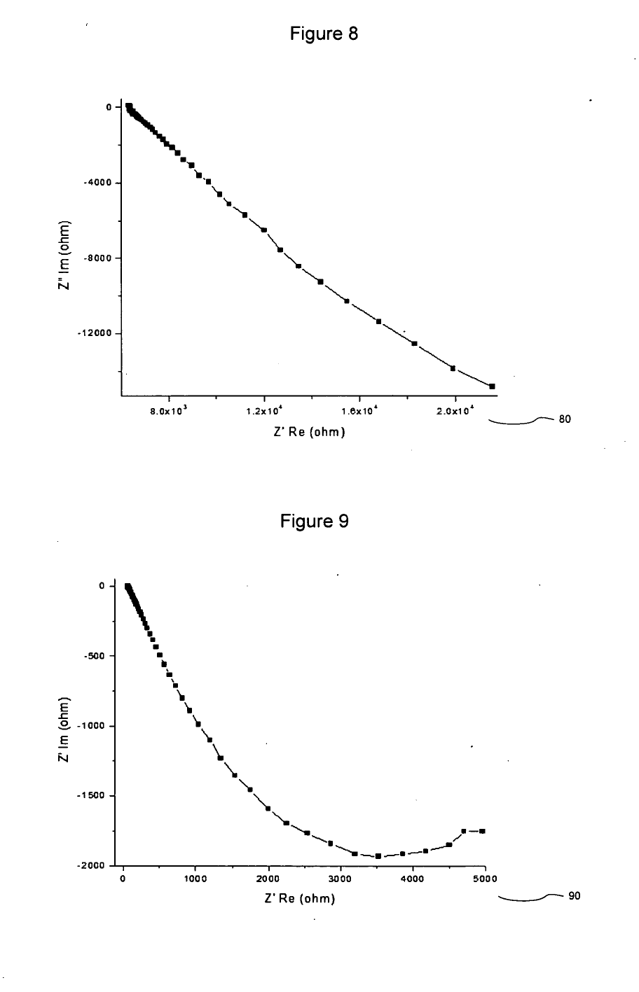

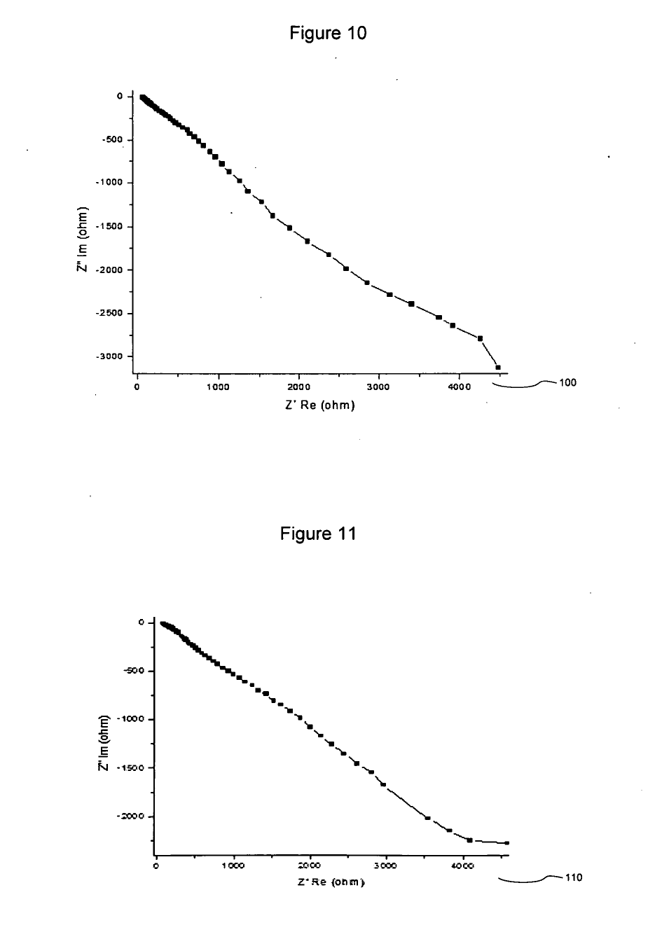

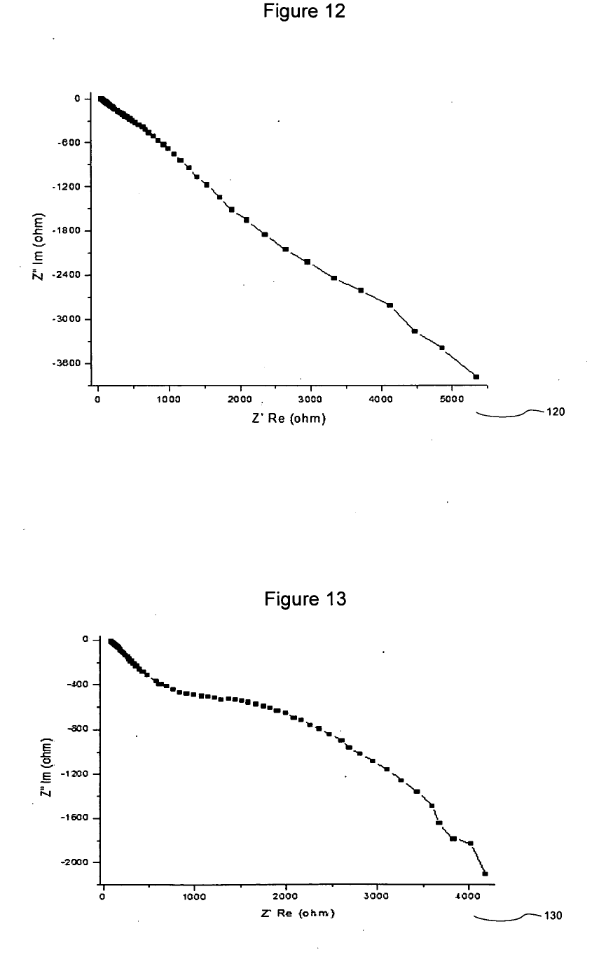

FIGS. 7 to 13 show some data diagrams of measured data measured for different conditions. These data diagrams of impedance of electrodes are obtained during dynamic measurement under different conditions. The X coordinate denotes the resistance character and the Y coordinate denotes the capacitive character. FIG. 7 is a Nyquist plot of the electrodes measured without a membrane. FIG. 8 is a Nyquist plot of the electrodes measured on a membrane. FIG. 9 is a Nyquist plot of the measured electrodes moving on a membrane in one dimension. FIG. 10 is a Nyquist plot of the measured electrodes moving on a membrane in two dimensions. FIG. 11 is a Nyquist plot of the measured electrodes remaining statically on a membrane when the electrolyte is flowed by a pump. FIG. 12 is a Nyquist plot of the measured electrodes moving in one dimension on a membrane when the electrolyte is flowed by a pump at room temperature. FIG. 13 is a Nyquist plot of the measured electrodes moving in one dimension on a membrane when the electrolyte is flowed by a pump at high temperature.

Modifications and improvement of the contact between a textile electrode and artificial skin is envisaged by adding an adhesive layer to enhance electrical measurement and reduce the signal noise.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A method for determining the performance of a wearable electrode, the method comprising:
simulating a static or dynamic environment using at least a container of liquid;
passing an electrical current through the liquid of the container;
wherein predetermined properties of the electrode in response to passing the electrical current through the liquid during operation in the simulated environment are analysed and recorded to determine the performance of the electrode.

2. The method according to claim 1, wherein the simulated environment includes any one from the group consisting of: simulating a skin condition, circulation of the liquid, setting a temperature for the liquid and/or container, and moving the container.

3. The method according to claim 1, wherein the predetermined properties of the electrode include any one from the group consisting of: impedance, voltage offset, noise and durability.

4. The method according to claim 1, wherein the electrode is positioned in direct contact with the liquid or is in contact with a membrane or solid cover covering the container of liquid.

5. The method according to claim 4, wherein the membrane is an artificial membrane or a natural skin such as an animal skin.

6. The method according to claim 5, wherein the artificial membrane is ventilated, water-resistant or is a soaked membrane.

7. The method according to claim 4, wherein the solid cover is made from any one from the group consisting of: organic material and polymeric material without ion release.

8. The method according to claim 1, wherein the liquid is any one from the group consisting of: human perspiration, artificial perspiration, and a solution of electrolytes to simulate water found inside cells, intracellular fluid (ICF) or extracellular fluid (ECF) of a living organism, the electrolytes containing Cl⁻Na⁺K⁺,Ca⁺, H⁺, O⁻, Mg⁺, Mn⁺, Cr⁺, Fe⁺, or Ir⁺.

9. The method according to claim 1, wherein the electrode is rigid or flexible.

10. The method according to claim 8, wherein the frequency of the electrical current is altered from a low frequency to simulate passing through the ECF to a high frequency to simulate passing through both the ICF and ECF.

11. The method according to claim 4, wherein a medical gel or conductive gel is applied between the electrode and the membrane or solid cover.

12. The method according to claim 2, wherein the container is moved using any one from the group consisting of: a multidimensional movement system, manual stage controllers and computer-assisted stage controllers.

13. A system for determining the performance of a wearable electrode, the system comprising:
a container of liquid to simulate a static or dynamic environment for the electrode;
a measurement module to analyse and record predetermined properties of the electrode in response to passing an electrical current through the liquid during operation in the simulated environment to determine the performance of the electrode.

14. The system according to claim 13, further comprising a force control module to mechanically move the electrode.

15. The system according to claim 13, wherein there are two measurement modules

16. The system according to claim 13, wherein the electrode is positioned in direct contact with the liquid or is in contact with a membrane or solid cover covering the container of liquid.

17. The system according to claim 16, wherein the membrane is an artificial membrane or a natural skin such as an animal skin.

18. The system according to claim 17, wherein the artificial membrane is ventilated, water-resistant or is a soaked membrane.

19. The system according to claim 16, wherein the solid cover is made from any one from the group consisting of: organic material and polymeric material without ion release.

20. The system according to claim 13, wherein the liquid is any one from the group consisting of: human perspiration, artificial perspiration, and a solution of electrolytes to simulate water found inside cells, intracellular fluid (ICF) or extracellular fluid (ECF) of a living organism, the electrolytes containing Cl⁻Na⁺K⁺,Ca⁺, H⁺, O⁻, Mg⁺, Mn⁺, Cr⁺, Fe⁺, or Ir⁺.

21. The system according to claim 14, wherein the force control module is any one from the group consisting of: a multidimensional movement system, manual stage controllers and computer-assisted stage controllers.

22. A system for simulating static and dynamic profiles for determining the performance of an electrode, comprising:
liquid containers containing artificial sweat;
a fluid circulation system configured to simulate fluid circulation in a living organism by circulating the artificial sweat between the liquid containers in accordance with a predetermined profile;
heaters configured to heat the artificial sweat in at least one of the liquid containers in accordance with the predetermined profile;
a mechanical movement system configured to simulate the effect of movement of a living body in accordance with the predetermined profile when an electrical signal is measured by the electrode;
measured sample holders configured to hold said electrode;
contacts between said electrode and the container of electrolyte;
a signal generator configured to provide an electrical waveform to said electrode via the measured sample holders; and
a measurement module configured to collect data concerning the performance of the electrode and the system profile.
